(19) United States
(12) Patent Application Publication
(10) Pub. No.: US 2016/0017198 A1
(43) Pub. Date: Jan. 21, 2016

(54) FLUORINE-CONTAINING NANO-SILICA COMPOSITE PARTICLES AND METHOD FOR PRODUCING THE SAME

(71) Applicants: UNIMATEC CO., LTD., Minato-ku Tokyo (JP); HIROSAKI UNIVERSITY, Hirosaki-shi, Aomori (JP)

(72) Inventors: Katsuyuki Sato, Ibaraki (JP); Hideo Sawada, Aomori (JP)

(21) Appl. No.: 14/773,173

(22) PCT Filed: Mar. 6, 2014
(86) PCT No.: PCT/JP2014/055818

§ 371 Date: Sep. 4, 2015

(30) Foreign Application Priority Data
Mar. 6, 2013 (JP) 2013-044081
Mar. 6, 2013 (JP) 2013-044082
Mar. 6, 2013 (JP) 2013-044083

(51) Int. Cl. C09K 3/18; C08K 3/36

(52) U.S. Cl. CPC C09K 3/18; C08K 3/36

(57) ABSTRACT

Fluorine-containing nano-silica composite particles comprising a condensate of a fluorine-containing alcohol represented by the general formula:

R_{F}-A-OH [I]
wherein R_{F} is a perfluoroalkyl group or a polyfluoroalkyl group in which some of the fluorine atoms of the perfluoroalkyl group are replaced by hydrogen atoms, and A is an alkylene group having 1 to 6 carbon atoms; and an alkoxysilane with nano-silica particles,
or fluorine-containing nano-silica composite particles comprising a condensate of a fluorine-containing alcohol represented by the general formula:

R_{F}′-A-OH [Ia]

or the general formula:

HO-A-R_{F}″-A-OH [Ib]
wherein R_{F}′ is a linear or branched perfluoroalkyl group containing an O, S, or N atom, R_{F}″ is a linear or branched perfluoroalkylene group containing an O, S, or N atom, and A is an alkylene group having 1 to 6 carbon atoms; and an alkoxysilane with nano-silica particles.

### TECHNICAL FIELD

The present invention relates to fluorine-containing nano-silica composite particles and a method for producing the same. More particularly, the present invention relates to fluorine-containing nano-silica composite particles using a fluorine-containing alcohol, and a method for producing the same.

### BACKGROUND ART

Patent Document 1 discloses a liquid, fluorine-containing and single-component composition for the permanent oil- and water-repellent surface treatment of porous and nonporous substrates, wherein the composition comprises a suitable stabilizing component and a hydrophilic silane component in combination, and has excellent storage stability, and hydrophobic, oleophobic and dust proof properties.

However, in the preparation of a surface treating agent for mineral and non-mineral substrates, a highly toxic isocyanate compound is used to introduce a silyl group into a fluorine compound. Therefore, its implementation requires the regulation of the production environment. Moreover, perfluorooctanoic acid and a fluorine-containing alcohol containing a perfluoroalkyl group having 8 or more carbon atoms, which is a precursor of perfluorooctanoic acid, are used, although less use of them is currently desired in terms of the current state of the environment.

### PRIOR ART DOCUMENTS

### Patent Documents

Patent Document 1: JP-A-2011-511113

Patent Document 2: JP-B-4674604

Patent Document 3: WO 2007/080949 A1

Patent Document 4: JP-A-2008-38015

Patent Document 5: U.S. Pat. No. 3,574,770

### OUTLINE OF THE INVENTION

### Problem to be Solved by the Invention

An object of the present invention is to provide fluorine-containing nano-silica composite particles having excellent water- and oil-repellency, and using a fluorine-containing alcohol which does not produce perfluorooctanoic acid and the like, even when released into the environment, in the case of a perfluoroalkyl group having less than 8 carbon atoms, and to provide a method for producing the same.

### Means for Solving the Problem

The present invention provides fluorine-containing nano-silica composite particles comprising a condensate of a fluorine-containing alcohol represented by the general formula:

R_{F}-A-OH [I]

wherein R_{F} is a perfluoroalkyl group or a polyfluoroalkyl group in which some of the fluorine atoms of the perfluoroalkyl group are replaced by hydrogen atoms, and A is an alkylene group having 1 to 6 carbon atoms; and an alkoxysilane with nano-silica particles.

The fluorine-containing nano-silica composite particles are produced by a method comprising subjecting the above fluorine-containing alcohol [I] and an alkoxysilane to a condensation reaction in the presence of nano-silica particles using an alkaline or acidic catalyst. The obtained fluorine-containing nano-silica composite particles are used as an active ingredient of surface treating agents, such as water- and oil-repellents.

Moreover, the present invention provides fluorine-containing nano-silica composite particles comprising a condensate of a fluorine-containing alcohol represented by the general formula:

R_{F}′-A-OH [Ia]

or the general formula:

HO-A-R_{F}″-A-OH [Ib]

wherein R_{F}′ is a linear or branched perfluoroalkyl group containing an O, S, or N atom, R_{F}″ is a linear or branched perfluoroalkylene group containing an O, S, or N atom, and A is an alkylene group having 1 to 6 carbon atoms; and an alkoxysilane with nano-silica particles.

The fluorine-containing nano-silica composite particles are produced by a method comprising subjecting the above fluorine-containing alcohol [Ia] or [Ib] and an alkoxysilane to a condensation reaction in the presence of nano-silica particles using an alkaline or acidic catalyst. The obtained fluorine-containing nano-silica composite particles are used as an active ingredient of surface treating agents, such as water- and oil-repellents.

### Effect of the Invention

The fluorine-containing nano-silica composite particles according to the present invention not only have excellent water- and oil-repellency, but also can be stably dispersed in polar solvents, such as water, alcohol, and tetrahydrofuran. The fluorine-containing nano-silica composite particles also have excellent heat resistance at a high temperature (e.g., 800° C.). Specifically, the increase in the composite particle diameter and the value of weight loss at a high temperature are reduced. Moreover, a perfluoroalkyl group having less than 8 carbon atoms do not lead to environmental pollution because they do not produce perfluorooctanoic acid and the like when released into the environment.

### EMBODIMENTS FOR CARRYING OUT THE INVENTION

The fluorine-containing alcohol [I] is, for example, a polyfluoroalkyl alcohol represented by the general formula:

CₙF₂ₙ₊₁(CH₂)ⱼOH [II]
n: 1 to 10, preferably 1 to 6
j: 1 to 6, preferably 2

The alkylene group A is, for example, a —CH₂— group, —CH₂CH₂— group, or the like. Examples of perfluoroalkyl alkyl alcohols having such an alkylene group include 2,2,2-trifluoroethanol (CF₃CH₂OH), 3,3,3-trifluoropropanol (CF₃CH₂CH₂OH), 2,2,3,3,3-pentafluoropropanol (CF₃CF₂CH₂OH), 3,3,4,4,4-pentafluorobutanol (CF₃CF₂CH₂CH₂OH), 2,2,3,3,4,4,5,5,5-nonafluoropentanol (CF₃CF₂CF₂CF₂CH₂OH), 3,3,4,4,5,5,6,6,6-nonafluorohexanol (CF₃CF₂CF₂CF₂CH₂CH₂OH), 3,3,4,4,5,5,6,6,7,7,8,8,8-tridecafluorooctanol (CF₃CF₂CF₂CF₂CF₂CF₂CH₂CH₂OH), and the like.

Moreover, a polyfluoroalkyl group refers to a group in which the terminal —CF₃ group of a perfluoroalkyl group is replaced by, for example, a —CF₂H group. Examples thereof include 2,2,3,3-tetrafluoropropanol (HCF₂CF₂CH₂OH), 2,2,3,4,4,4-hexafluorobutanol (CF₃CHFCF₂CH₂OH), 2,2,3,3,4,4,5,5-octafluoropentanol (HCF₂CF₂CF₂CF₂CH₂OH), and the like.

The polyfluoroalkyl alcohol represented by the general formula [II] is described, for example, in Patent Document 2, and is synthesized through the following series of steps.

First, a polyfluoroalkyl iodide represented by the general formula:

CₙF₂ₙ₊₁(CF₂CF₂)_{b}(CH₂CH₂)_{c}I

is reacted with N-methylformamide HCONH(CH₃) to form a mixture of polyfluoroalkyl alcohol and its formate. Then, the mixture is hydrolyzed in the presence of an acid catalyst, thereby forming a polyfluoroalkyl alcohol of the formula:

CₙF₂ₙ₊₁(CF₂CF₂)_{b}(CH₂CH₂)_{c}OH

Examples of the polyfluoroalkyl iodide include the following:

CF₃(CH₂CH₂)I

CF₃(CH₂CH₂)₂I

C₂F₅(CH₂CH₂)I

C₂F₅(CH₂CH₂)₂I

C₃F₇(CH₂CH₂)I

C₃F₇(CH₂CH₂)₂I

C₄F₉(CH₂CH₂)I

C₄F₉(CH₂CH₂)₂I

C₂F₅(CF₂CF₂)(CH₂CH₂O

C₂F₅(CF₂CF₂)(CH₂CH₂)₂I

C₂F₅(CF₂CF₂)₂(CH₂CH₂)I

C₂F₅(CF₂CF₂)₂(CH₂CH₂)₂I

C₂F₅(CF₂CF₂)₃(CH₂CH₂)I

C₄F₉(CF₂CF₂)(CH₂CH₂O

C₄F₉(CF₂CF₂)₂(CH₂CH₂)I

C₄F₉(CF₂CF₂)(CH₂CH₂)₂I

C₄F₉(CF₂CF₂)₂(CH₂CH₂)₂I

C₄F₉(CF₂CF₂)₃(CH₂CH₂)I

The fluorine-containing alcohol [I] may also be a fluorine-containing alcohol wherein the R_{F} group is a polyfluoroalkyl group having 3 to 20 carbon atoms, preferably 6 to 10 carbon atoms, and A is an alkylene group having 2 to 6 carbon atoms, preferably 2 carbon atoms. Examples thereof include a polyfluoroalkyl alcohol represented by the general formula:

CₙF₂ₙ₊₁(CH₂CF₂)ₐ(CF₂CF₂)_{b}(CH₂CH₂)_{c}OH [III]
n: 1 to 6, preferably 2 to 4
a: 1 to 4, preferably 1
b: 0 to 3, preferably 1 or 2
c: 1 to 3, preferably 1

The polyfluoroalkyl alcohol represented by the general formula [III] is disclosed in Patent Document 2, and synthesized through the following series of steps.

First of all, a polyfluoroalkyl iodide represented by the general formula:

CₙF₂ₙ₊₁(CH₂CF₂)ₐ(CF₂CF₂)_{b}(CH₂CH₂)_{c}I

is reacted with N-methylformamide HCONH(CH₃) to form a mixture of polyfluoroalkyl alcohol and its formate. The mixture is then subjected to a hydrolysis reaction in the presence of an acid catalyst to form a polyfluoroalkyl alcohol of the formula:

CₙF₂ₙ₊₁(CH₂CF₂)ₐ(CF₂CF₂)_{b}(CH₂CH₂)_{c}OH

Examples of the polyfluoroalkyl iodide include the following:

CF₃(CH₂CF₂)(CH₂CH₂)I

C₂F₅(CH₂CF₂)(CH₂CH₂)I

C₂F₅(CH₂CF₂)(CH₂CH₂)₂I

C₃F₇(CH₂CF₂)(CH₂CH₂O

C₃F₇(CH₂CF₂)(CH₂CH₂)₂I

C₄F₉(CH₂CF₂)(CH₂CH₂O

C₄F₉(CH₂CF₂)(CH₂CH₂)₂I

C₂F₅(CH₂CF₂)(CF₂CF₂)(CH₂CH₂O

C₂F₅(CH₂CF₂)(CF₂CF₂)(CH₂CH₂)₂I

C₂F₅(CH₂CF₂)₂(CF₂CF₂)(CH₂CH₂O

C₂F₅(CH₂CF₂)₂(CF₂CF₂)(CH₂CH₂)₂I

C₄F₉(CH₂CF₂)(CF₂CF₂)(CH₂CH₂O

C₄F₉(CH₂CF₂)₂(CF₂CF₂)(CH₂CH₂O

C₄F₉(CH₂CF₂)(CF₂CF₂)(CH₂CH₂)₂I

C₄F₉(CH₂CF₂)₂(CF₂CF₂)(CH₂CH₂)₂I

The fluorine-containing alcohol [Ia] is, for example, a fluorine-containing alcohol wherein the R_{F}′ group is a perfluoroalkyl group having 3 to 305 carbon atoms, preferably 8 to 35 carbon atoms, and A is an alkylene group having 1 to 3 carbon atoms, preferably 1 carbon atom. Examples thereof include a hexafluoropropene oxide oligomer alcohol represented by the general formula:

CₘF₂ₘ₊₁O[CF(CF₃)CF₂O]_{d}CF(CF₃)(CH₂)ₑOH [IIa]
m: 1 to 3, preferably 1
d: 0 to 100, preferably 2 to 50
e: 1 to 3, preferably 1

Moreover, the fluorine-containing alcohol [Ib] may be a fluorine-containing alcohol wherein the R_{F}″ group is a perfluoroalkylene group having 5 to 160 carbon atoms, and A is an alkylene group having 1 to 3 carbon atoms, preferably 1 carbon atom. Examples thereof include a perfluoroalkylene ether diol represented by the general formula:

HO(CH₂)_{f}CF(CF₃)[OCF₂CF(CF₃)]_{g}O(CF₂)ₕO[CF(CF₃)CF₂O]ᵢCF(CF₃)(CH₂)_{f}OH [IIb]
f: 1 to 3, preferably 1
g+i: 0 to 50, preferably 2 to 50
h: 1 to 6, preferably 2

Among hexafluoropropene oxide oligomer alcohols represented by the general formula [IIa], a compound wherein m is 1 and e is 1 is described in Patent Document 3, and synthesized through the following step.

A fluorine-containing ether carboxylic acid alkyl ester represented by the general formula: CF₃O[CF(CF₃)CF₂O]ₙCF(CF₃)COOR (R: an alkyl group, n: an integer of 0 to 12) is subjected to a reduction reaction using a reducing agent, such as sodium boron hydride.

Moreover, a perfluoroalkylene ether diol represented by the general formula [IIb] wherein f=1 is disclosed in Patent Documents 4 and 5, and synthesized via the following series of steps:

FOCRfCOF→H₃COOCRfCOOCH₃→HOCH₂RfCH₂OH

Rf:—C(CF₃)[OCF₂C(CF₃)]ₐO(CF₂)_{c}O[CF(CF₃)CF₂O]_{b}CF(CF₃)—

Such a fluorine-containing alcohol and an alkoxysilane are reacted in the presence of an alkaline or acidic catalyst, thereby forming fluorine-containing nano composite particles.

The alkoxysilane is represented by the general formula:

(R₁O)ₚsi(OR₂)_{q}(R₃)ᵣ [IV]
R₁, R₃: H, C₁-C₆ alkyl group, or aryl group
R₂: C₁-C₆ alkyl group or aryl group,
   with the proviso that not all of R₁, R₂, and R₃ are aryl groups
p+q+r: 4, with the proviso that q is not 0
   examples thereof include trimethoxysilane, triethoxysilane, trimethoxymethylsilane, triethoxymethylsilane, trimethoxyphenylsilane, triethoxyphenylsilane, tetramethoxysilane, tetraethoxysilane, and the like.

The reaction between these components is performed in the presence of an alkaline or acid catalyst, such as aqueous ammonia, an aqueous solution of a hydroxide of an alkali metal or alkaline earth metal (e.g., sodium hydroxide, potassium hydroxide, or calcium hydroxide), hydrochloric acid, or sulfuric acid, at a temperature of about 0 to 100° C., preferably about 10 to 30° C., for about 0.5 to 48 hours, preferably about 1 to 10 hours.

The amount of fluorine-containing alcohol in the obtained fluorine-containing nano composite particles is about 1 to 50 mol %, preferably about 5 to 30 mol %. The composite particle size (measured by a dynamic light scattering method) is about 30 to 200 nm.

In the production of such a fluorine-containing nano composite, a condensation reaction with coexistence of organo nano-silica particles in the reaction system can produce fluorine-containing nano-silica composite particles in which a condensate comprising three components, i.e., a fluorine-containing alcohol, an alkoxysilane, and nano-silica particles, is formed.

As the nano-silica particles, organosilica sol having an average particle diameter (measured by a dynamic light scattering method) of 5 to 200 nm, preferably 10 to 100 nm, and having a primary particle diameter of 40 nm or less, preferably 5 to 30 nm, more preferably 10 to 20 nm, is used. Practically used are commercial products of Nissan Chemical Industries, Ltd., such as Methanol Silica Sol, Snowtex IPA-ST (isopropyl alcohol dispersion), Snowtex EG-ST (ethylene glycol dispersion), Snowtex MEK-ST (methyl ethyl ketone dispersion), and Snowtex MIBK-ST (methyl isobutyl ketone dispersion).

The ratio of these components is such that about 1 to 99 parts by weight, preferably about 10 to 50 parts by weight, of fluorine-containing alcohol, and about 1 to 99 parts by weight, preferably about 10 to 50 parts by weight, of alkoxysilane are used based on 100 parts by weight of the nano-silica particles. When the ratio of the fluorine-containing alcohol used is less than this range, water- and oil-repellency decreases. In contrast, when the ratio of the fluorine-containing alcohol used is greater than this range, dispersibility in solvents becomes poor. Moreover, when the ratio of alkoxysilane used is less than this range, dispersibility in solvents becomes poor. In contrast, when the ratio of alkoxysilane used is greater than this range, water- and oil-repellency decreases.

In the fluorine-containing nano-silica composite particles obtained as a reaction product, it is considered that the fluorine-containing alcohol is linked to a hydroxyl group on the surface of the nano-silica particles via a siloxane bond as a spacer. Therefore, the chemical and thermal stability of silica, and the excellent water- and oil-repellency, antifouling properties, and the like of fluorine are effectively exhibited. In fact, a glass surface treated with the fluorine-containing nano-silica composite particles exhibits excellent water- and oil-repellency, and also has the effect of, for example, reducing the weight loss at 800° C. Moreover, the particle size of the nano-silica composite particles, and the variation of the particle size show small values. The nano-silica composite particles are formed as a reaction product of a fluorine-containing alcohol, an alkoxysilane, and nano-silica particles; however, other components are allowed to be mixed as long as the object of the present invention is not impaired.

### EXAMPLES

The following describes the present invention with reference to Examples.

### Example 1

CF₃(CF₂)₃(CH₂)₂OH [FA-4] (0.25 g) was added and dissolved in 30 ml of methanol. To the resulting solution, 1.67 g (0.50 g as nano-silica) of silica sol (Methanol Silica Sol, a product of Nissan Chemical Industries, Ltd.; nano-silica content: 30 wt. %, average particle diameter: 11 nm) and 0.25 ml of tetraethoxysilane (a product of Tokyo Chemical Industry Co., Ltd.; density: 0.93 g/ml) were added. While stirring the mixture with a magnetic stirrer, 0.25 ml of 25 wt. % aqueous ammonia was added, and the mixture was reacted for 5 hours.

After completion of the reaction, the methanol and aqueous ammonia were removed using an evaporator under reduced pressure, and the resulting powder was redispersed in approximately 20 ml of methanol overnight. The next day, centrifugation was performed using a centrifuge tube, the supernatant was removed, and fresh methanol was added to perform rinsing. After rinsing was performed 3 times, the opening of the centrifuge tube was covered with aluminum foil, and the tube was placed in an oven at 70° C. overnight. The next day, the tube was placed and dried in a vacuum dryer at 50° C. overnight, thereby obtaining 0.582 g (yield: 71%) of white powder.

The particle size of the obtained white powdery fluorine-containing nano-silica composite particles, and the variation of the particle size were measured in a methanol dispersion having a solid matters content of 1 g/L at 25° C. by a dynamic light scattering (DLS) measurement method. Further, thermogravimetric analysis (TGA) was performed before calcining and after calcining up to 800° C. The heating rate in this case was 10° C./min. Moreover, the percentage of the weight loss due to calcining sintering with respect to the initial weight was also calculated.

Further, the dispersibility of the composite particles dispersed with a solid matters content of 1 wt. % in water [H₂O], methanol [MeOH], ethanol [EtOH], 1,2-dichloroethane [DCE], and tetrahydrofuran [THF] was visually observed, and the results were evaluated according to the following evaluation criteria.

◯: Uniformly dispersed, transparent dispersion

Δ: Slightly dispersed, cloudy dispersion

x: Not dispersed, precipitated in dispersion medium

### Examples 2 to 5

In Example 1, the amount of 25 wt. % aqueous ammonia was variously changed.

### Examples 6 to 10

In Examples 1 to 5, the same amount (0.25 g) of CF₃(CF₂)₅(CH₂)₂OH [FA-6; C₂F₅(CF₂CF₂)₂(CH₂CH₂)OH] was used as the fluorine-containing alcohol.

### Examples 11 to 15

In Examples 1 to 5, the same amount (0.25 g) of CF₃(CF₂)₇(CH₂)₂OH [FA-8; C₂F₅(CF₂CF₂)₃(CH₂CH₂)OH] was used as the fluorine-containing alcohol.

Table 1 below shows the amount of aqueous ammonia, recovered amount, yield, and various measurement results in the above Examples. Further, Table 2 shows the evaluation of dispersibility.

The yield was calculated by the following formula on the assumption that tetraalkoxysilane underwent a self-condensation reaction to form three-dimensional siloxane bonds Si—O and generate a —O—Si—O—[SiO₂] skeleton among them. When silica is not used, the yield is calculated based on C═O.

Yield (%)=A/[B+C+(D×E×F/G)]×100

A: weight of produced composite (g)

B: weight of fluorine-containing alcohol (g)

C: weight of silica (g)

D: volume of tetraalkoxysilane (ml)

E: density of tetraalkoxysilane (g/ml)

F: molar weight (g/mol) of SiO₂ derived from tetraalkoxysilane

G: molar weight (g/mol) of tetraalkoxysilane

TABLE 1

| | | | | Fluorine-containing nano-silica | | |
|---|---|---|---|---|---|---|
| | aq. | Recovery | | composite particle size (nm) | | |
| | NH₃ | amount | Yield | Before | After calcining | Weight |
| Ex. | (ml) | (g) | (%) | calcining | up to 800° C. | loss (%) |
| 1 | 0.25 | 0.582 | 71 | 36.8 ± 9.9 | 39.0 ± 3.1 | 7 |
| 2 | 0.50 | 0.559 | 68 | 30.1 ± 7.3 | 39.5 ± 9.9 | 7 |
| 3 | 1.0 | 0.352 | 43 | 69.1 ± 13.9 | 45.3 ± 10.9 | 7 |
| 4 | 2.0 | 0.419 | 51 | 41.5 ± 10.2 | 42.6 ± 9.2 | 7 |
| 5 | 4.0 | 0.571 | 70 | 34.0 ± 7.6 | 139.8 ± 25.5 | 7 |
| 6 | 0.25 | 0.500 | 61 | 35.3 ± 8.3 | 53.3 ± 11.4 | 8 |
| 7 | 0.50 | 0.580 | 71 | 40.5 ± 11.3 | 40.5 ± 12.0 | 6 |
| 8 | 1.0 | 0.590 | 72 | 40.5 ± 13.0 | 62.3 ± 18.5 | 6 |
| 9 | 2.0 | 0.488 | 60 | 105.3 ± 19.0 | 97.5 ± 30.2 | 7 |
| 10 | 4.0 | 0.426 | 52 | 45.4 ± 13.2 | 60.9 ± 17.1 | 6 |
| 11 | 0.25 | 0.521 | 64 | 41.7 ± 13.7 | 81.7 ± 21.6 | 7 |
| 12 | 0.50 | 0.481 | 59 | 28.2 ± 6.0 | 32.2 ± 9.8 | 6 |
| 13 | 1.0 | 0.475 | 58 | 56.6 ± 11.5 | 53.7 ± 10.2 | 6 |
| 14 | 2.0 | 0.516 | 63 | 53.6 ± 11.4 | 55.1 ± 14.5 | 6 |
| 15 | 4.0 | 0.565 | 69 | 39.7 ± 9.2 | 35.4 ± 12.8 | 7 |

TABLE 2

| Ex. | H₂O | MeOH | EtOH | DCE | THF |
|---|---|---|---|---|---|
| 1 | Δ | ∘ | ∘ | ∘ | ∘ |
| 2 | ∘ | ∘ | ∘ | ∘ | ∘ |
| 3 | ∘ | ∘ | ∘ | ∘ | ∘ |
| 4 | ∘ | ∘ | ∘ | ∘ | ∘ |
| 5 | ∘ | ∘ | ∘ | ∘ | ∘ |
| 6 | ∘ | ∘ | ∘ | ∘ | ∘ |
| 7 | ∘ | ∘ | ∘ | ∘ | ∘ |
| 8 | Δ | ∘ | ∘ | ∘ | ∘ |
| 9 | ∘ | ∘ | ∘ | ∘ | ∘ |
| 10 | ∘ | ∘ | ∘ | ∘ | ∘ |
| 11 | ∘ | ∘ | ∘ | ∘ | ∘ |
| 12 | ∘ | ∘ | ∘ | ∘ | ∘ |
| 13 | ∘ | ∘ | ∘ | ∘ | ∘ |
| 14 | ∘ | ∘ | ∘ | ∘ | ∘ |
| 15 | ∘ | ∘ | ∘ | ∘ | ∘ |

### Reference Examples 1 to 3

In Examples 13 to 15, methanol silica sol was not used.

Table 3 below shows the amount of aqueous ammonia, produced fluorine-containing nano composite particle, recovered amount, yield, and various measurement results in the above Reference Examples 1 to 3. Further, Table 4 shows the evaluation of dispersibility.

TABLE 3

| | | | | Fluorine-containing nano | | |
|---|---|---|---|---|---|---|
| | | | | composite particle size | | |
| | | | | (nm) | | |
| Refer- | aq. | Recovery | | | After | |
| ence | NH₃ | amount | Yield | Before | calcining up | Weight |
| Ex. | (ml) | (g) | (%) | calcining | to 800° C. | loss (%) |
| 1 | 1.0 | 0.065 | 20 | 54.5 ± 12.0 | 16.6 ± 3.8 | 18 |
| 2 | 2.0 | 0.059 | 19 | 21.1 ± 6.0 | 26.4 ± 6.0 | 17 |
| 3 | 4.0 | 0.065 | 20 | 37.3 ± 8.1 | 49.6 ± 11.2 | 17 |

TABLE 4

| Reference | | | | | |
|---|---|---|---|---|---|
| Ex. | H₂O | MeOH | EtOH | DCE | THF |
| 1 | ∘ | ∘ | ∘ | ∘ | ∘ |
| 2 | ∘ | ∘ | ∘ | ∘ | ∘ |
| 3 | Δ | ∘ | ∘ | ∘ | ∘ |

### Examples 21 to 35, and Reference Examples 11 to 13

Prepared glass slides were dipped in methanol dispersions (particle concentration: 5 g/L) of the fluorine-containing nano-silica composite particles before calcining (Examples 21 to 35) and the fluorine-containing nano composite particles before calcining (Reference Examples 11 to 13) obtained in Examples 1 to 15 and Reference Examples 1 to 3, and then dried at room temperature. Droplets (4 μl) were gently brought into contact with the obtained thin layer surfaces at room temperature, and the contact angle (unit: °) of the droplets adhering to n-dodecane or water was measured by the θ/2 method using a contact angle meter (Drop Master 300, produced by Kyowa Interface Science Co., Ltd.). The contact angle with water was measured with time. Table 5 below shows the obtained results.

TABLE 5

| | | | Water (elapsed time: min.) | | | | | | |
|---|---|---|---|---|---|---|---|---|---|
| Example | Composite | Dodecane | 0 | 5 | 10 | 15 | 20 | 25 | 30 |
| Ex. 21 | Ex. 1 | 35 | 21 | 10 | 0 | 0 | 0 | 0 | 0 |
| Ex. 22 | Ex. 2 | 7 | 22 | 17 | 15 | 13 | 11 | 10 | 7 |
| Ex. 23 | Ex. 3 | 4 | 7 | 0 | 0 | 0 | 0 | 0 | 0 |
| Ex. 24 | Ex. 4 | 0 | 7 | 0 | 0 | 0 | 0 | 0 | 0 |
| Ex. 25 | Ex. 5 | 0 | 0 | 0 | 0 | 0 | 0 | 0 | 0 |
| Ex. 26 | Ex. 6 | 49 | 28 | 0 | 0 | 0 | 0 | 0 | 0 |
| Ex. 27 | Ex. 7 | 46 | 48 | 27 | 26 | 24 | 20 | 20 | 17 |
| Ex. 28 | Ex. 8 | 16 | 19 | 19 | 16 | 14 | 13 | 10 | 8 |
| Ex. 29 | Ex. 9 | 14 | 11 | 0 | 0 | 0 | 0 | 0 | 0 |
| Ex. 30 | Ex. 10 | 19 | 16 | 7 | 0 | 0 | 0 | 0 | 0 |
| Ex. 31 | Ex. 11 | 114 | 37 | 34 | 33 | 31 | 30 | 30 | 28 |
| Ex. 32 | Ex. 12 | 108 | 61 | 58 | 52 | 49 | 46 | 45 | 41 |
| Ex. 33 | Ex. 13 | 123 | 59 | 17 | 0 | 0 | 0 | 0 | 0 |
| Ex. 34 | Ex. 14 | 125 | 23 | 13 | 10 | 8 | 0 | 0 | 0 |
| Ex. 35 | Ex. 15 | 127 | 91 | 18 | 4 | 0 | 0 | 0 | 0 |
| Ref. Ex. 11 | Ref. Ex. 1 | 50 | 52 | 48 | 45 | 38 | 34 | 29 | 25 |
| Ref. Ex. 12 | Ref. Ex. 2 | 45 | 62 | 54 | 47 | 44 | 37 | 33 | 25 |
| Ref. Ex. 13 | Ref. Ex. 3 | 43 | 35 | 29 | 26 | 22 | 18 | 14 | 9 |

### Examples 41 to 45

In Examples 1 to 5, the same amount (0.25 g) of CF₃(CF₂)₃CH₂(CF₂)₅(CH₂)₂OH [DTFA; C₄F₉(CH₂CF₂)(CF₂CF₂)₂(CH₂CH₂)OH] was used as the fluorine-containing alcohol.

Table 6 below shows the amount of aqueous ammonia, recovered amount, yield, and various measurement results in the above Examples 41 to 45. Further, Table 7 shows the evaluation of dispersibility.

TABLE 6

| | | | | Fluorine-containing | | |
|---|---|---|---|---|---|---|
| | | | | nano-silica | | |
| | | Recovery | | composite particle size (nm) | | |
| | aq. NH₃ | amount | Yield | Before | After calcining | Weight |
| Ex. | (ml) | (g) | (%) | calcining | up to 800° C. | loss (%) |
| 41 | 0.25 | 0.580 | 71 | 54.5 ± 19.3 | 71.9 ± 15.3 | 7 |
| 42 | 0.50 | 0.604 | 74 | 44.3 ± 13.8 | 46.2 ± 10.4 | 7 |
| 43 | 1.0 | 0.523 | 64 | 55.6 ± 12.3 | 53.1 ± 14.7 | 8 |
| 44 | 2.0 | 0.504 | 62 | 53.6 ± 10.3 | 54.0 ± 12.9 | 6 |
| 45 | 4.0 | 0.578 | 71 | 63.6 ± 14.1 | 72.0 ± 15.5 | 6 |

TABLE 7

| Ex. | H₂O | MeOH | EtOH | DCE | THF |
|---|---|---|---|---|---|
| 41 | ∘ | ∘ | ∘ | ∘ | ∘ |
| 42 | ∘ | ∘ | ∘ | ∘ | ∘ |
| 43 | ∘ | ∘ | ∘ | ∘ | ∘ |
| 44 | ∘ | ∘ | ∘ | ∘ | ∘ |
| 45 | ∘ | ∘ | ∘ | ∘ | ∘ |

### Reference Examples 21 to 23

In Examples 43 to 45, methanol silica sol was not used.

Table 8 below shows the amount of aqueous ammonia, produced fluorine-containing nano composite particle, recovered amount, yield, and various measurement results in the above Reference Examples 21 to 23. Further, Table 9 shows the evaluation of dispersibility.

TABLE 8

| | | | | Fluorine-containing nano | | |
|---|---|---|---|---|---|---|
| | | | | composite particle size | | |
| | | | | (nm) | | |
| Refer- | aq. | Recovery | | | After | |
| ence | NH₃ | amount | Yield | Before | calcining up | Weight |
| Ex. | (ml) | (g) | (%) | calcining | to 800° C. | loss (%) |
| 21 | 1.0 | 0.072 | 23 | 41.0 ± 8.7 | 16.3 ± 3.9 | 17 |
| 22 | 2.0 | 0.044 | 14 | 47.5 ± 10.1 | 24.4 ± 5.7 | 20 |
| 23 | 4.0 | 0.069 | 22 | 81.5 ± 14.5 | 24.2 ± 5.6 | 25 |

TABLE 9

| Reference | | | | | |
|---|---|---|---|---|---|
| Ex. | H₂O | MeOH | EtOH | DCE | THF |
| 21 | ∘ | ∘ | ∘ | ∘ | ∘ |
| 22 | ∘ | ∘ | ∘ | ∘ | ∘ |
| 23 | ∘ | ∘ | ∘ | ∘ | ∘ |

### Examples 46 to 50

Using methanol dispersions (particle concentration: 5 g/L) of the fluorine-containing nano-silica composite particles before calcining obtained in Examples 41 to 45, the contact angle (unit: °) of the droplets adhering to n-dodecane or water was measured by the above mentioned method. The contact angle with water was measured with time. Table 10 below shows the obtained results.

TABLE 10

| | | | Water (elapsed time: min.) | | | | | | |
|---|---|---|---|---|---|---|---|---|---|
| Ex. | Composite | Dodecane | 0 | 5 | 10 | 15 | 20 | 25 | 30 |
| 46 | Ex. 41 | 82 | 30 | 21 | 20 | 14 | 9 | 0 | — |
| 47 | Ex. 42 | 71 | 64 | 61 | 58 | 56 | 55 | 52 | 52 |
| 48 | Ex. 43 | 55 | 79 | 77 | 75 | 68 | 61 | 58 | 52 |
| 49 | Ex. 44 | 80 | 95 | 75 | 63 | 57 | 50 | 47 | 42 |
| 50 | Ex. 45 | 47 | 113 | 82 | 72 | 64 | 57 | 53 | 49 |

### Examples 61 to 65

In Example 2, the same amount (0.25 g) of each of the following compounds was used as the fluorine-containing alcohol.

CF₃(CF₂)₂OCF(CF₃)CF₂OCF(CF₃)CH₂OH[PO-3-OH] Ex.61:

CF₃(CF₂)₂O[CF(CF₃)CF₂O]₄CF(CF₃)CH₂OH[PO-6-OH] Ex.62:

HOCH₂CF(CF₃)OCF₂CF(CF₃)OCF₂CF₂OCF(CF₃)CH₂OH[OXF3PO—OH] Ex.63:

HOCH₂CF(CF₃)[OCF₂CF(CF₃)]ₙOCF₂CF₂O[CF(CF₃)CF₂O]ₘ—CF(CF₃)CH₂OH(n+m=6)[OXF8PO—OH] Ex.64:

HOCH₂CF(CF₃)[OCF₂CF(CF₃)]ₙOCF₂CF₂O[CF(CF₃)CF₂O]ₘ—CF(CF₃)CH₂OH(n+m=12)[OXF14PO—OH] Ex.65:

Table 11 below shows the amount of aqueous ammonia, recovered amount, yield, and various measurement results in the above Examples 61 to 65. Further, Table 12 shows the evaluation of dispersibility.

TABLE 11

| | | | | Fluorine-containing nano-silica | | |
|---|---|---|---|---|---|---|
| | aq. | Recovery | | composite particle size (nm) | | |
| | NH₃ | amount | Yield | Before | After calcining | Weight |
| Ex. | (ml) | (g) | (%) | calcining | up to 800° C. | loss (%) |
| 61 | 0.5 | 0.556 | 68 | 42.2 ± 4.2 | 35.2 ± 8.4 | 5 |
| 62 | 0.5 | 0.580 | 71 | 130.5 ± 27.5 | 29.8 ± 5.8 | 7 |
| 63 | 0.5 | 0.466 | 57 | 55.5 ± 7.9 | 23.7 ± 7.1 | 5 |
| 64 | 0.5 | 0.359 | 44 | 96.9 ± 10.9 | 30.0 ± 6.9 | 11 |
| 65 | 0.5 | 0.507 | 62 | 90.8 ± 14.9 | 47.2 ± 9.7 | 20 |

TABLE 12

| Ex. | H₂O | MeOH | EtOH | DCE | THF |
|---|---|---|---|---|---|
| 61 | ∘ | ∘ | ∘ | ∘ | ∘ |
| 62 | ∘ | ∘ | ∘ | ∘ | ∘ |
| 63 | ∘ | ∘ | ∘ | ∘ | ∘ |
| 64 | ∘ | ∘ | ∘ | ∘ | ∘ |
| 65 | ∘ | ∘ | ∘ | ∘ | ∘ |

### Reference Examples 31 to 33

In Example 61, methanol silica sol was not used, and the amount of 25% aqueous ammonia was variously changed.

### Reference Examples 34 to 36

In Example 62, methanol silica sol was not used, and the amount of 25% aqueous ammonia was variously changed.

### Reference Example 37

In Example 63, methanol silica sol was not used, and the amount of 25% aqueous ammonia was changed to 4.0 ml.

### Reference Example 38

In Example 64, methanol silica sol was not used, and the amount of 25% aqueous ammonia was changed to 4.0 ml.

### Reference Example 39

In Example 65, methanol silica sol was not used, and the amount of 25% aqueous ammonia was changed to 4.0 ml.

Table 13 below shows the amount of aqueous ammonia, produced fluorine-containing nano composite particle, recovered amount, yield, and various measurement results in the above Reference Examples 31 to 39. Further, Table 14 shows the evaluation of dispersibility.

TABLE 13

| | | | | Fluorine-containing nano | | |
|---|---|---|---|---|---|---|
| | | | | composite particle size | | |
| | | | | (nm) | | |
| Refer- | aq. | Recovery | | | After | |
| ence | NH₃ | amount | Yield | Before | calcining up | Weight |
| Ex. | (ml) | (g) | (%) | calcining | to 800° C. | loss (%) |
| 31 | 1.0 | 0.073 | 23 | 48.3 ± 4.8 | 34.2 ± 4.4 | 16 |
| 32 | 2.0 | 0.073 | 23 | 53.1 ± 5.1 | 38.0 ± 9.2 | 12 |
| 33 | 4.0 | 0.067 | 21 | 45.1 ± 6.5 | 51.1 ± 16.8 | 12 |
| 34 | 1.0 | 0.070 | 22 | 141.5 ± 31.8 | 26.6 ± 6.3 | 16 |
| 35 | 2.0 | 0.048 | 15 | 80.2 ± 31.2 | 80.5 ± 1.2 | 13 |
| 36 | 4.0 | 0.063 | 20 | 69.2 ± 10.1 | 69.4 ± 12.5 | 12 |
| 37 | 4.0 | 0.051 | 16 | 60.5 ± 12.4 | 55.1 ± 12..1 | 12 |
| 38 | 4.0 | 0.063 | 20 | 55.7 ± 8.9 | 65.4 ± 12.1 | 13 |
| 39 | 4.0 | 0.171 | 54 | 63.2 ± 6.7 | 53.5 ± 7.8 | — |

TABLE 14

| Reference | | | | | |
|---|---|---|---|---|---|
| Ex. | H₂O | MeOH | EtOH | DCE | THF |
| 31 | ∘ | ∘ | ∘ | ∘ | ∘ |
| 32 | ∘ | ∘ | ∘ | ∘ | ∘ |
| 33 | ∘ | ∘ | ∘ | ∘ | ∘ |
| 34 | ∘ | ∘ | ∘ | ∘ | ∘ |
| 35 | Δ | ∘ | ∘ | ∘ | ∘ |
| 36 | ∘ | ∘ | ∘ | ∘ | ∘ |
| 37 | ∘ | ∘ | ∘ | ∘ | ∘ |
| 38 | Δ | ∘ | ∘ | ∘ | ∘ |
| 39 | ∘ | ∘ | ∘ | ∘ | ∘ |

### Examples 66 to 70

Using the methanol dispersions (particle concentration: 5 g/L) of the fluorine-containing nano-silica composite particles before calcining obtained in above Examples 61 to 65, the contact angle (unit: °) of the droplets adhering to n-dodecane or water was measured by the above mentioned method. The contact angle with water was measured with time. Table 15 below shows the obtained results.

TABLE 15

| | | | Water (elapsed time: min.) | | | | | | |
|---|---|---|---|---|---|---|---|---|---|
| Ex. | Composite | Dodecane | 0 | 5 | 10 | 15 | 20 | 25 | 30 |
| 66 | Ex. 61 | 72 | 23 | 0 | 0 | 0 | 0 | 0 | 0 |
| 67 | Ex. 62 | 62 | 0 | 0 | 0 | 0 | 0 | 0 | 0 |
| 68 | Ex. 63 | 49 | 18 | 0 | 0 | 0 | 0 | 0 | 0 |
| 69 | Ex. 64 | 51 | 24 | 11 | 0 | 0 | 0 | 0 | 0 |
| 70 | Ex. 65 | 66 | 17 | 0 | 0 | 0 | 0 | 0 | 0 |

1. Fluorine-containing nano-silica composite particles comprising a condensate of a fluorine-containing alcohol represented by the general formula:
R_{F}-A-OH [I]
wherein R_{F} is a perfluoroalkyl group or a polyfluoroalkyl group in which some of the fluorine atoms of the perfluoroalkyl group are replaced by hydrogen atoms, and A is an alkylene group having 1 to 6 carbon atoms; and an alkoxysilane with nano-silica particles.

2. The fluorine-containing nano-silica composite particles according to claim 1, wherein the fluorine-containing alcohol represented by the general formula [I] is a polyfluoroalkyl alcohol represented by the general formula:
CₙF₂ₙ₊₁(CH₂)ⱼOH [II]
wherein n is an integer of 1 to 10, and j is an integer of 1 to 6.

3. The fluorine-containing nano-silica composite particles according to claim 1, wherein the fluorine-containing alcohol represented by the general formula [I] is a polyfluoroalkyl alcohol represented by the general formula:
CₙF₂ₙ₊₁(CH₂CF₂)ₐ(CF₂CF₂)_{b}(CH₂CH₂)_{c}OH [III]
wherein n is an integer of 1 to 6, a is an integer of 1 to 4, b is an integer of 0 to 3, and c is an integer of 1 to 3.

4. The fluorine-containing nano-silica composite particles according to claim 1, wherein the alkoxysilane is a silane derivative represented by the general formula:
(R₁O)ₚSi(OR₂)_{q}(R₃)ᵣ [IV]
wherein R₁ and R₃ are each a hydrogen atom, an alkyl group having 1 to 6 carbon atoms, or an aryl group; R₂ is an alkyl group having 1 to 6 carbon atoms or an aryl group, with the proviso that not all of R₁, R₂, and R₃ are aryl groups; and p+q+r is 4, with the proviso that q is not 0.

5. A method for producing fluorine-containing nano-silica composite particles, the method comprising subjecting the fluorine-containing alcohol [I] according to claim 1 and an alkoxysilane to a condensation reaction in the presence of nano-silica particles using an alkaline or acidic catalyst.

6. Fluorine-containing nano-silica composite particles comprising a condensate of a fluorine-containing alcohol represented by the general formula:
R_{F}′-A-OH [Ia]
or the general formula:
HO-A-R_{F}″-A-OH [Ib]
wherein R_{F}′ is a liner or branched perfluoroalkyl group containing an O, S, or N atom, R_{F}″ is a linear or branched perfluoroalkylene group containing an O, S, or N atom, and A is an alkylene group having 1 to 6 carbon atoms; and an alkoxysilane with nano-silica particles.

7. The fluorine-containing nano-silica composite particles according to claim 6, wherein the fluorine-containing alcohol represented by the general formula [Ia] is a hexafluoropropene oxide oligomer alcohol represented by the general formula:
CₘF₂ₘ₊₁O[CF(CF₃)CF₂O]_{d}CF(CF₃)(CH₂)ₑOH [IIa]
wherein m is an integer of 1 to 3, d is an integer of 0 to 100, and e is an integer of 1 to 3.

8. The fluorine-containing nano-silica composite particles according to claim 6, wherein the fluorine-containing alcohol represented by the general formula [Ib] is a perfluoroalkylene ether diol represented by the general formula:
HO(CH₂)_{f}CF(CF₃)[OCF₂CF(CF₃)]_{g}O(CF₂)ₕO[CF(CF₃)CF₂O],CF(CF₃)(CH₂)_{f}OH [IIb]
wherein f is an integer of 1 to 3, g+i is an integer of 0 to 50, and h is an integer of 1 to 6.

9. The fluorine-containing nano-silica composite particles according to claim 6, wherein the alkoxysilane is a silane derivative represented by the general formula:
(R₁O)ₚSi(OR₂)_{q}(R₃)ᵣ [III]
wherein R₁ and R₃ are each a hydrogen atom, an alkyl group having 1 to 6 carbon atoms, or an aryl group; R₂ is an alkyl group having 1 to 6 carbon atoms or an aryl group, with the proviso that not all of R₁, R₂, and R₃ are aryl groups; and p+q+r is 4, with the proviso that q is not 0.

10. A method for producing fluorine-containing nano-silica composite particles, the method comprising subjecting the fluorine-containing alcohol [Ia] or [Ib] according to claim 6 and an alkoxysilane to a condensation reaction in the presence of nano-silica particles using an alkaline or acidic catalyst.
